(19) United States
(12) Patent Application Publication
(10) Pub. No.: US 2026/0080065 A1
(43) Pub. Date: Mar. 19, 2026

(54) CONFIGURATION SETTING VERIFICATION

(71) Applicant: Micron Technology, Inc., Boise, ID (US)

(72) Inventors: John M. Gonzales, Boise, ID (US); Christopher G. Wieduwilt, Boise, ID (US); Seth A. Eichmeyer, Boise, ID (US); Matthew D. Jenkinson, Boise, ID (US)

(21) Appl. No.: 19/324,299

(22) Filed: Sep. 10, 2025

Related U.S. Application Data
(60) Provisional application No. 63/695,123, filed on Sep. 16, 2024.

(51) Int. Cl. G06F 21/57

(52) U.S. Cl. CPC G06F 21/575; G06F 2221/034

(57) ABSTRACT

An apparatus may include an array of non-volatile memory cells, a protected memory configured to store: configuration settings for the apparatus, and a lock bit, a controller coupled to the array and to the protected memory and configured to: read the protected memory in response to an initialization of the apparatus, prevents alteration of data stored in the protected memory in response to the lock bit having a first value, and allow alteration of the data stored in the protected memory in response to the lock bit having a second value.

### PRIORITY INFORMATION

This Application claims the benefits of U.S. Provisional Application No. 63/695,123, filed on Sep. 16, 2024, the contents of which are incorporated herein by reference.

### TECHNICAL FIELD

The present disclosure relates generally to semiconductor memory and methods, and more particularly, to apparatuses, systems, and methods for configuration setting verification.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random-access memory (DRAM), static random-access memory (SRAM), synchronous dynamic random-access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random-access memory (RRAM), and magnetoresistive random access memory (MRAM), such as spin torque transfer random access memory (STT RAM), among others.

Flash memory devices can include a charge storage structure, such as is included in floating gate flash devices and charge trap flash (CTF) devices, which may be utilized as non-volatile memory for a wide range of electronic applications. Flash memory devices may use a one-transistor memory cell that allows for high memory densities, high reliability, and low power consumption.

Memory cells in an array architecture can be programmed to a target state. For example, electric charge can be placed on or removed from the floating gate of a memory cell to put the cell into one of a number of data states. For example, a single level cell (SLC) can be programmed to one of two data states representing one of two units of data (e.g., 1 or 0). Multilevel memory cells (MLCs) can be programmed to one of more than two data states. For example, an MLC capable of storing two units of data can be programmed to one of four data states, an MLC capable of storing three units of data can be programmed to one of eight data states, and an MLC capable of storing four units of data can be programmed to one of sixteen data states. MLCs can allow the manufacture of higher density memories without increasing the number of memory cells since each cell can represent more than one unit of data (e.g., more than one bit). However, MLCs can present difficulties with respect to sensing operations as the ability to distinguish between adjacent data states may deteriorate over time and/or operation.

### BRIEF DESCRIPTION OF THE DRAWINGS

The present disclosure will be understood more fully from the detailed description given below and from the accompanying drawings of various embodiments of the disclosure.

FIG. 1 illustrates an example electronic system that includes a host, a controller, and a device in accordance with various embodiments of the present disclosure.

FIG. 2 is a block diagram of an example of a method for verifying configuration data in accordance with some embodiments of the present disclosure.

FIG. 3 illustrates an example of a device and method for verifying configuration data in accordance with some embodiments of the present disclosure.

FIG. 4 illustrates an example of a device and method for verifying configuration data in accordance with some embodiments of the present disclosure.

FIG. 5 is a flow diagram of an example method for verifying configuration settings in accordance with some embodiments of the present disclosure.

FIG. 6 is a block diagram of an example computer system in which embodiments of the present disclosure may operate.

### DETAILED DESCRIPTION

Aspects of the present disclosure are directed to configuration setting verification circuitry. In some embodiments, the configuration setting verification circuitry can be utilized to verify data stored in a protected memory portion of a memory device. The data stored in the protected memory portion can include configuration settings such as, but not limited to trim settings and/or read error management settings. The trim settings and read error management settings can be utilized to ensure the memory device maintains functionality and/or performance. Alterations to the configuration settings stored in the protected memory portion can result in functional failure of the memory device and/or data loss of the memory device.

In previous examples, a key (e.g., guard key, test mode key, etc.) or other type of security protocol can be provided to allow access or alteration to the data stored in the protected memory portion. In these previous examples, it is possible for a user or unauthorized user to access the key and make alterations to the data of the protected memory, which can lead to functional failures or performance degradation. In some embodiments, the data (e.g., trim settings, read error management settings, configuration settings, etc.) of the protected memory portion of the memory device can be expected or intended to be static for the operational life of the memory device. For this reason, it can be beneficial to add security trims in order to protect the data stored in the protected memory portion of the memory device to prevent corruption of the data. As used herein, security trims can be trim settings that are designated to provide security for the memory device, such as, but not limited to the protected memory potion.

In order to address these and other deficiencies of current approaches, embodiments of the present disclosure can utilize a configuration setting verification circuitry. The configuration setting verification circuitry can utilize a lock bit to prevent alteration of data stored by the protected memory portion of the memory device. In other embodiments, the configuration setting verification circuitry can utilize a verification value indicator to determine when to calculate a verification value associated with the configuration settings stored by the protected memory portion of the memory device.

In these embodiments, the protected memory portion of the memory device can include a stored verification value and a stored verification value indicator. The stored verification value can be a value calculated utilizing the configuration settings stored by the protected memory portion of the memory device. For example, the stored verification value can be a cyclic redundancy check (CRC) value, a checksum value, a multiple input signature register (MISR) value, and/or similar calculated value utilizing the configuration settings as input values to calculate the value. In this way, the configuration settings can be written to registers (e.g., complimentary metal oxide semiconductor (CMOS) registers, comprising volatile memory) of the memory device upon initialization and the configuration settings can be utilized to regenerate the verification value and/or calculate a subsequent verification value that can be compared to the stored verification value.

The configuration settings can be verified or determined to be correct when the subsequent verification value matches the stored verification value. In contrast, the configuration settings can be determined to be incorrect or altered from a factory setting when the subsequent verification value does not match the stored verification value. In this way, the memory device can verify the configuration settings during an initialization of the memory device to avoid utilizing configuration settings that may damage the memory device or may be unauthorized configuration settings for the memory device.

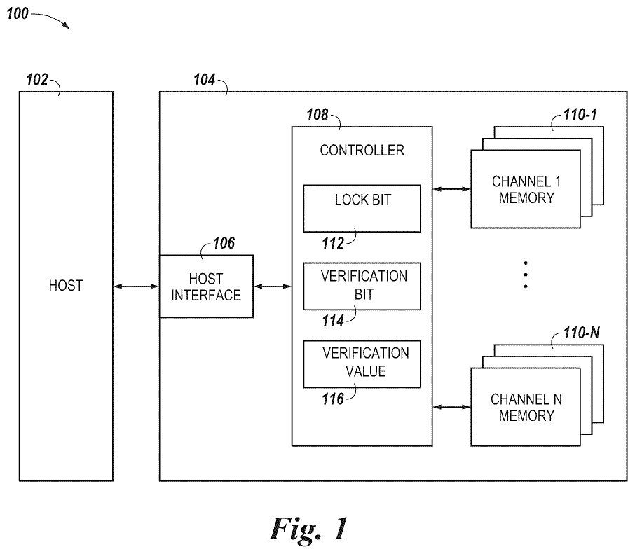

FIG. 1 is a block diagram of an apparatus in the form of a computing system 100 including at least one memory system 104 in accordance with the present disclosure. As used herein, a memory system 104, a controller 108, or a memory device 110 (e.g., memory devices 110-1, 110-2 collectively referred to as memory device 110, etc.) might also be separately considered an “apparatus.” The memory system 104 can be a flash drive or a solid state drive (SSD), for instance, and can include a host interface 106, a controller 108 (e.g., a processor and/or other control circuitry), and a number of memory devices 110-1, . . . , 110-N (e.g., solid state memory devices such as NAND memory devices), which provide a storage volume for the memory system 104.

As illustrated in FIG. 1, the controller 108 can be coupled to the host interface 106 and to the memory devices 110 via a plurality of channels and can be used to transfer data between the memory system 104 and a host 102. In some embodiments, the controller 108 can be embedded within the memory devices 110 such that the controller 108, channels, and memory devices 110-1, 110-2 are part of a single apparatus. For example, in some embodiments, the components or functions of the controller 108 described herein can be NAND device logic that is located on the NAND chip. That is, although the elements of FIG. 1 are illustrated as separate components, embodiments are not so limited. In some embodiments, the memory system 104 can be an apparatus.

The interface 106 can be in the form of a standardized interface. For example, when the memory system 104 is used for data storage in a computing system 100, the interface 106 can be a serial advanced technology attachment (SATA), peripheral component interconnect express (PCIe), or a universal serial bus (USB), among other connectors and interfaces. In general, however, interface 106 can provide an interface for passing control, address, data, and other signals between the memory system 104 and a host 102 having compatible receptors for the interface 106.

Host 102 can be a host system such as a personal laptop computer, a desktop computer, a digital camera, a mobile telephone, or a memory card reader, among various other types of hosts. Host 102 can include a system motherboard and/or backplane and can include a number of memory access devices (e.g., a number of processors).

The controller 108 can communicate with the memory devices 110 to control data read, write, and erase operations, among other operations. Although not specifically illustrated, in some embodiments, the controller 108 can include a discrete memory channel controller for each channel coupling the controller 108 to the memory devices 110. The controller 108 can include, for example, a number of components in the form of hardware and/or firmware (e.g., one or more integrated circuits) and/or software for controlling access to the number of memory devices 110 and/or for facilitating data transfer between the host 102 and memory devices 110.

The memory devices 110 can include a number of arrays of memory elements (e.g., memory cells). For example, the memory devices 110 can be NAND memory devices. However, embodiments are not limited to a particular type of memory array or array architecture.

In operation, data can be written to and/or read from a memory device of a memory system (e.g., memory devices 110 of system 104) as a physical page of data, for example. As one example, a NAND memory device may be configured to store a particular quantity of bytes of data per page. As such, a physical page of data can be referred to as a data transfer size of the memory system. Data can be transferred to/from a host (e.g., host 102) in data segments referred to as sectors (e.g., host sectors). As such, a sector of data can be referred to as a data transfer size of the host. A sector of data is a logical granularity that can be remapped to a variety of different underlying system granularities.

In some embodiments, and as illustrated in FIG. 1, the controller 108 can include lock bit circuitry 112 (e.g., lock bit writing circuitry), verification bit circuitry 114, and verification circuitry 116. Each of the lock bit circuitry 112, the verification circuitry 114, and the verification value circuitry 116 can be discrete components such as an application specific integrated circuit (ASIC) or the components may reflect functionally provided by circuitry within the controller 108 that does not necessarily have a discrete physical form separate from other portions of the controller 108. Although illustrated as components within the controller 108 in FIG. 1, each of the lock bit circuitry 112, verification bit circuitry 114, and verification circuitry 116 can be external to the controller 108 or have a number of components located within the controller 108 and a number of components located external to the controller 108. For example, the lock bit circuitry 112 can include a number of lock bit coding circuits located on the controller 108 and a number of lock bit coding circuits located external to the controller 108. Although various functions may be described with respect to the lock bit circuitry 112, verification bit circuitry 114, and verification circuitry 116, the various functions may equally be said to be performed by the controller 108.

The lock bit circuitry 112 can be configured to cause a lock bit to be written to the protected memory. The lock bit can be utilized to allow or prevent access to the protected memory during a test operation. In other embodiments, the lock bit circuitry 112 can be configured to cause the protected memory to be read in response to an initialization of the apparatus. For example, the lock bit circuitry 112 can cause the lock bit to be read from the protected memory to determine a value of the lock bit. In these embodiments, the lock bit circuitry 112 can be configured to prevent alteration of data stored in the protected memory in response to the lock bit having a first value. In these embodiments, the lock bit circuitry 112 can be configured to allow alteration of the data stored in the protected memory in response to the lock bit having a second value.

The verification bit circuitry 114 can be configured to cause a verification value enabled indicator to be written to the protected memory. In some embodiments, the verification value enabled indicator can be a designated bit that can be written with a first value to indicate that a verification value is to be calculated or written with a second value to indicate that a verification value is not to be calculated. In these embodiments, the verification value enabled indicator can indicate whether the protected memory portion is further protected utilizing a verification value calculated utilizing configuration data stored by the protected memory.

The verification value circuitry 116 can be configured to calculate a subsequent verification value based on the device configuration settings stored to the protected memory in response to reading the verification value enabled indicator. The verification value circuitry 116 can be configured to compare the subsequent verification value to the initial verification value stored in the protected memory. In some embodiments, the verification value circuitry 116 can verify the device configuration settings in response to the subsequent verification value matching the initial verification value.

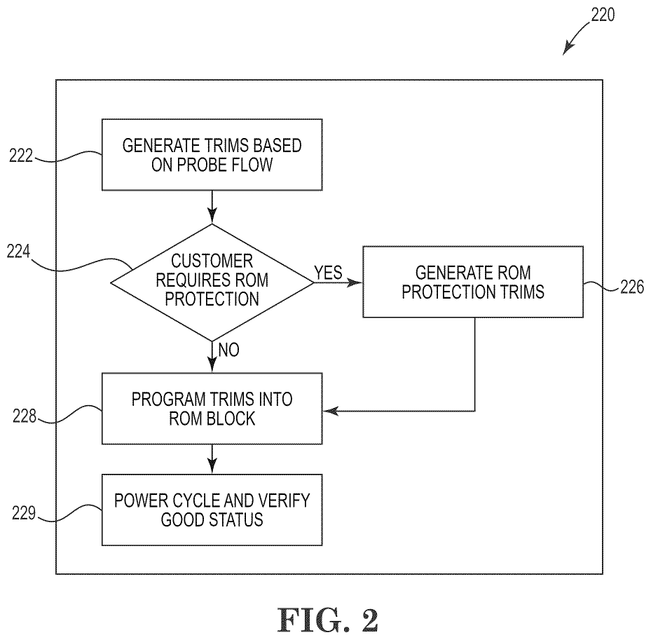

FIG. 2 is a block diagram of an example of a method 220 for verifying configuration data in accordance with some embodiments of the present disclosure. The method 220 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 220 is performed by the controller 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

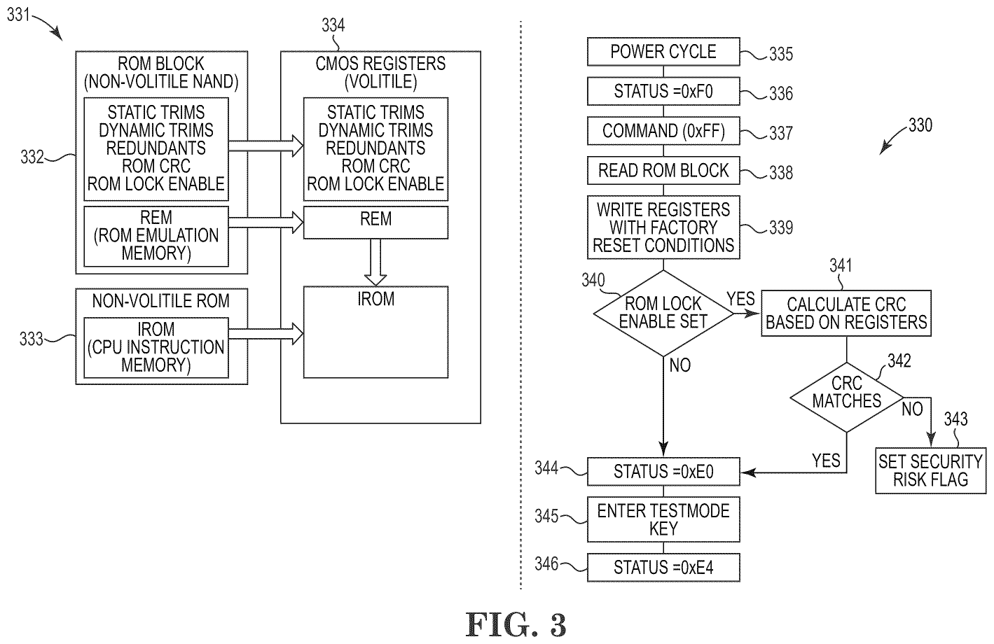

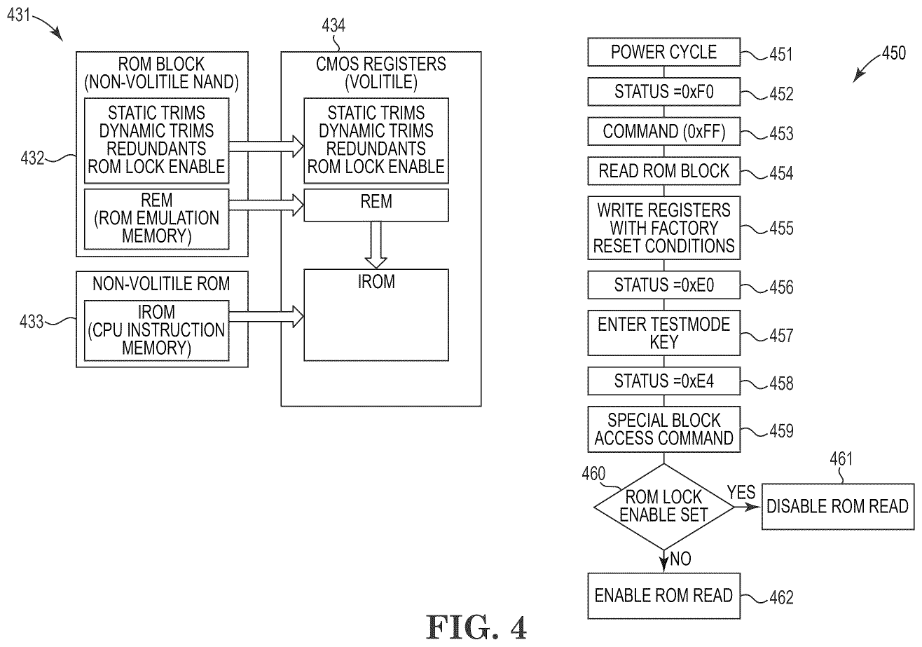

The method 220 can be executed in association with the manufacture of a memory device or thereafter (e.g., before shipping to a customer). That is, in some embodiments, the method 220 can be utilized by a manufacturer of a memory device to provide greater security of protected memory portions of a memory device compared to previous systems and methods. As described herein, the protected memory portions of the memory device can be read only memory (ROM) portions of the memory device that are utilized to store configuration settings (e.g., trims settings, error management settings, etc.). In some embodiments, the method 220 can be performed to generate a memory device that includes the functions described further herein. For example, the method 220 can be executed to generate a ROM block that includes one or more of a ROM lock bit, a ROM verification bit, and/or a ROM verification value. In these embodiments, the resulting memory device can be device 331 as referenced in FIG. 3 or device 431 as referenced in FIG. 4.

At 222, trims can be generated (e.g., trim settings, etc.), by a controller, based on probe flow. As used herein, the trim settings can refer to instructions that help manage and/or optimize the performance and longevity of the memory device. In some embodiments, the trim settings can include, but are not limited to instructions for: voltage and timing adjustments, wear leveling, error correction, garbage collection, and/or over-provisioning. In some embodiments, the trim settings can be executed by the firmware of the memory device.

As used herein, a probe flow can be part of a calibration of a memory device (e.g., NAND memory device, etc.). The probe flow can capture data associated with flow characteristics (e.g., electrical flow, etc.) of the memory device. The trims can be generated based on the flow characteristics of the memory device such that the trims are specific to the particular properties of the memory device. In this way, the generated trims can be intended to be utilized for the lifespan of the memory device.

At 224, a determination can be made whether a customer requires ROM protection. In some embodiments, the customer can refer to an end user of the memory device generated by the method 220. In some embodiments, customer requirements can refer to system requirements of a host or other type of device that are intended to utilize the memory device generated by the method 220. In some embodiments, the method 220 at 224 can be executed to determine whether a particular memory device requires the ROM protection.

In some embodiments, the method 220 can be executed at 226 to generate ROM protection trims when the ROM protection is indicated to be a requirement for the memory device. In some embodiments, the ROM protection trims can be instructions that can be stored or programmed to a ROM block to allow the ROM protection trims to be executed by a device or system. In some embodiments, the ROM protection trims can include, but are not limited to: a ROM lock bit, a ROM verification bit, and/or a ROM verification value. In these embodiments, the ROM lock bit, the ROM verification bit, and/or the ROM verification value can be unique to the particular memory device being generated.

In some embodiments, a ROM lock bit can be programmed to a designated register bit of the ROM block. In these embodiments, the ROM block can be permanently restricted from being altered in a test mode when the ROM lock bit is a first value, and the ROM block may be accessible through the test mode when the ROM lock bit is a second value.

In other embodiments, a ROM verification bit can be a designated register bit of the ROM block. In these embodiments, the ROM verification bit can indicate that a ROM verification value is to be verified prior to allowing the ROM block to be accessed in a test mode. In these embodiments, the ROM verification bit can indicate that access to the test mode is accessible without verifying a ROM verification value.

In some embodiments, the ROM verification value can be a value that is calculated utilizing the configuration settings to be stored by the ROM block. For example, the configuration settings can be trim settings, read error management settings, or other settings that can be stored by the ROM block. In this example, the ROM verification value can be a cyclic redundancy check (CRC) value, a checksum value, a multiple input signature register (MISR) value, or other value calculated utilizing the configuration settings as numerical values. As described further herein, the ROM protection trims can be utilized to allow or prevent access to the ROM block.

In some embodiments, the method 220 can be executed at 228 to program trims into ROM block. In these embodiments, the trim settings and/or read error management settings can be programmed to the ROM block such that a device can access the settings during an initialization of the device. When the method 220 at 226 is executed, the ROM protection trims can be programmed to the ROM block at 228. In contrast, no ROM protection trims may be programmed or stored at the ROM block when the customer does not require ROM protection at 224 of the method 220.

In some embodiments, the method 220 can be executed at 229 to perform a power cycle and verify a status. In some embodiments, verifying the status can include verifying that the trim settings and/or other data were correctly programmed to the ROM block. In some embodiments, the ROM protection trims can also be verified. The ROM protection trims can be verified based on the type of ROM protection trims that were programmed to the ROM block. For example, the ROM lock bit can be verified utilizing a method similar to method 450 as referenced in FIG. 4 and the ROM verification bit/ROM verification value can be verified utilizing a method similar to method 330 as referenced in FIG. 3.

FIG. 3 illustrates an example of a device 331 and method 330 for verifying configuration data in accordance with some embodiments of the present disclosure. The method 330 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 330 is performed by the controller 108 of FIG. 1 and/or the device 331. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 335, a power cycle of the device 331 can be initiated. In some embodiments, initiating a power cycle can include starting or restarting a device 331, such as a memory device. When the power cycle is a restart of the device 331, the device 331 can prepare for power down by performing a data backup and closing operations of the device 331. The device 331 can perform the power down and disconnect the power from the memory device. The device 331 can then reconnect the power supply and begin the device initialization.

At 336 a status of the device 331 can be checked. In some embodiments, the status of the device can be determined to be “0xF0” or similar notation that can be a memory status flag for the device 331. When the status or memory status flag indicates that the device 331 is operational, the device 331 can receive or initiate a command at 337 of the method 330.

At 337 a command can be executed. The command can be “0xFF” or a similar command to indicate that the values of the registers 334 are all set to a particular value (e.g., value of “1”, etc.). This command can indicate that the values of the register 334 are ready to be programmed with the data stored by the ROM block 332. In this way, the command can indicate that the device 331 is ready to read the ROM block 332 and/or that the device 331 is prepared to program the data of the ROM block 332 to the registers 334.

At 338 the ROM block 332 can be read. Reading the ROM block 332 can include reading the data that is saved at the ROM block 332. As described herein, the ROM block 332 of the device 331 can be a portion of the memory device that is protected memory. As used herein, the protected memory can be a portion of the memory that is protected with security protocols to prevent unauthorized users from accessing or altering the data stored by the protected memory. In some embodiments, the ROM block 332 is a non-volatile NAND memory device that is designated to store configuration settings such as, but not limited to trim settings, static trim settings, dynamic trim settings, redundancies, read error management settings, among other settings utilized to configure the device 331.

At 339 to the factory reset conditions, static trims, dynamic trims, ROM CRC and/or ROM verification lock can be written to the registers 334 of the device 331. In some embodiments, the registers 334 can include volatile memory of the device 331 that can be utilized to control, monitor, and/or manage operations of the device 331. In some embodiments, the registers 334 can include, but are not limited to: configuration registers, command registers, error registers, interrupt registers, and/or other designated memory registers that can be programmed with data from the ROM block 332.

In some embodiments, the method 330 can be executed at 339 to write internal read-only memory (IROM) from a non-volatile ROM 333 to the registers 334 or write the IROM to volatile memory of the device 331. As used herein, the IROM can include additional settings that can be utilized to provide processor instructions or other types of instructions when the device 331 is operating.

In some embodiments, the ROM block 332 can include a ROM lock enabled indicator (e.g., verification value enabled indicator, ROM verification lock, ROM value bit, CRC bit, etc.). In some embodiments, the ROM lock enabled indicator can be a bit value that indicates whether to calculate a verification value when a test mode of the device 331 is requested. In some embodiments, the ROM lock enabled indicator can be a value that is programmed as protection trims during the configuration of the device 331. For example, the ROM lock enabled indicator can be a value programmed to the ROM block 332 at 226 of method 220 as referenced in FIG. 2.

In some embodiments, the ROM lock enabled indicator can be programmed to the registers 334 as a status register to indicate when a verification value is to be calculated to verify the configuration data stored by the ROM block 332. As described further herein, the ROM lock enabled indicator can be read to determine whether to calculate the verification value or whether to move directly to determining a status prior to entering a test mode verification (e.g., entering a test mode verification key, etc.).

At 340 a determination can be made as to whether the ROM lock enabled indicator (e.g., ROM verification lock) is enabled or disabled. As described herein, the ROM lock enabled indicator can be a status indicator value that can indicate whether there is a verification value (e.g., CRC value, ROM CRC, ROM checksum value, ROM MISR value, etc.) to check to verify the data stored by the ROM block 332 or whether there is no verification value. In a specific embodiment, the ROM block 332 includes a verification value when the ROM lock enabled indicator has a first value and the ROM block 332 does not include a verification value when the ROM lock enabled indicator has a second value.

At 341 to a CRC can be calculated based on the registers 334 when the ROM lock enabled indicator is determined to be enabled at 340. For example, the method 330 can be executed at 341 in response to the ROM lock enabled indicator being the first value. Although a ROM CRC or CRC value is described in the method 330, embodiments are not so limited. For example, other types of verification values can be utilized in a similar manner. For example, the verification value can be a checksum value, CRC value, and/or a MISR value generated using a particular algorithm on the configuration data stored by the ROM block 332 and appended to the configuration data. When verifying the verification value, the same algorithm is applied to the configuration data, and the resulting value is compared to the original verification value stored at the ROM block 332 or written to the registers 334. If the values match, the configuration data is considered intact or unaltered. If the values do not match, the configuration data is considered to have been corrupted or altered.

At 342 the calculated CRC can be compared to determine when the registers 334 matches a ROM CRC stored within the ROM block 332. As described herein, the method 330 can be executed to determine whether the verification value calculated utilizing the configuration data programmed to the registers 334 matches the verification value programmed to the ROM block 332. If the verification value is different, the method 330 can move to 343 and when the verification value is a match, the method 330 can move to 344. That is, if the verification values do not match it can be an indication that the configuration data stored by the ROM block 332 is different from the configuration data originally programmed to the ROM block 332. As described herein, changes to the originally programmed configuration data to the ROM block 332 can allow for security threats, altered performance, premature degradation, and/or other negative side effects associated with the device 331.

At 343 a security risk flag can be set when the calculated CRC from the registers 334 does not match a ROM CRC stored within the ROM block 332. As described herein, when the calculated CRC value or other type of verification value is different from the stored CRC value, it can indicate that the configuration settings of the ROM block 332 have been changed from their original programmed values and may damage the device 331 or cause technical issues if utilized. For this reason, a security risk flag can be set to notify a user that the configuration settings have been changed.

At 344 a status of the registers 334 are determined. In some embodiments, the status determined at 344 can indicate whether the registers were programmed correctly. In some embodiments, the status can be “0xE0” or similar status can indicate a particular status of the memory device 331. In some embodiments, the status at 344 can indicate whether a security flag at 343 is set or whether the subsequent CRC matches the CRC stored by the ROM block 332.

At 345 a test mode key is entered or received. In some embodiments, the method 330 can allow a user or host of the device 331 to access the ROM block 332 of the device 331 through a verification process that includes entering or providing an access key. In these embodiments, the method 330 can be executed to receive a test mode key to authorize a user or host device that is attempting to enter the test mode and/or access the ROM block 332.

At 346 a status of the test mode is determined. In some embodiments, determining the status of the test mode can refer to determining whether the test mode key provided at 345 was verified or denied. When the test mode key is verified, the device 331 can have a status at 346 to allow access to the ROM block 332. In contrast, the status of the test mode can prevent access to the ROM block 332 when the test mode key is not authorized.

The method 330 can be executed to utilize additional security trims for accessing the ROM block 332 of a device 331 compared to previous systems and methods. The method 330 can be executed to utilize the additional security trims that are added during production of the device 331 as illustrated in method 220 of FIG. 2. For example, the method 330 can be executed to utilize a ROM lock enable indicator stored on the ROM block 332 with a corresponding ROM CRC to ensure that the configuration settings stored by the ROM block 332 are verified prior to allowing an attempt to enter a test mode through a key verification process. In this way, the configuration settings can be verified or a security risk flag can be set prior to allowing a test mode to be entered by a user or host of the device 331.

FIG. 4 illustrates an example of a device 431 and method 450 for verifying configuration data in accordance with some embodiments of the present disclosure. In some embodiments, the device 431 can include the same or similar elements as device 331 as referenced in FIG. 3. For example, the device 431 can include a ROM block 432, a non-volatile ROM 433, and/or registers 434. In some embodiments, the method 450 can be executed to utilize a ROM lock bit (e.g., lock bit, one-time programmable (OTP) bit, etc.) to allow or prevent access to the configuration settings stored by the ROM block 432. For example, when the ROM lock bit is enabled, a test mode that allows the configuration settings to be altered within the ROM block 432.

At 451, a power cycle of the device 431 can be initiated. As described herein, initiating a power cycle can include starting or restarting a device 431, such as a memory device. The device 431 can prepare for power down by performing a data backup and closing operations, perform the power down and disconnect the power from the memory device, and then reconnect the power supply and begin the device initialization when the power cycle is a restart.

At 452 a status of the device 431 is determined. In some embodiments, the status of the device can be determined to be “0xF0” or similar notation that can be a memory status flag for the device 431. When the status or memory status flag indicates that the device 431 is operational, the device 431 can receive or initiate a command at 453.

At 453 a command is received at the device 431. The command can be “0xFF” or a similar command to begin reading the ROM block 432 or to continue a portion of the device initialization. In this way, the command can indicate that the device 431 is ready to read the ROM block 432 and/or that the device 431 is prepared to program the data of the ROM block 432 to the registers 434.

At 454 the ROM block 432 of the device 431 is read. Reading the ROM block 432 can include reading the data that is saved at the ROM block 432. As described herein, the ROM block 432 of the device 331 can be a portion of the memory device that is protected memory. As used herein, the protected memory can be a portion of the memory that is protected with security protocols to prevent unauthorized users from accessing or altering the data stored by the protected memory. In some embodiments, the ROM block 432 is a non-volatile NAND memory device that is designated to store configuration settings such as, but not limited to trim settings, static trim settings, dynamic trim settings, redundancies, read error management settings, among other settings utilized to configure the device 431.

At 455 the configuration settings of the ROM block 432 are written to the registers 434. As described herein, writing the configuration settings can include writing the factory reset conditions, static trims, dynamic trims and/or ROM lock enabled to the registers 434 of the device 431. In some embodiments, the registers 434 can include volatile memory of the device 431 that can be utilized to control, monitor, and/or manage operations of the device 431. In some embodiments, the registers 434 can include, but are not limited to: configuration registers, command registers, error registers, interrupt registers, and/or other designated memory registers that can be programmed with data from the ROM block 432.

In some embodiments, the method 430 can be executed at 455 to write internal read-only memory (IROM) from a non-volatile ROM 433 to the registers 434 or write the IROM to volatile memory of the device 431. As described herein, the IROM can include additional settings that can be utilized to provide processor instructions or other types of instructions when the device 431 is operating.

At 456 a status of the registers 434 is determined. In some embodiments, the status determined at 456 can indicate whether the registers were programmed correctly. In some embodiments, the status can be “0xE0” or similar status to indicate a particular status of the device 431 and/or registers 434. In some embodiments, the status can be followed by a command that indicates a user or host has initiated a test mode. In some embodiments, the test mode can allow access to the ROM block 432 of the device 431.

At 457 a test mode key 457 for the device 431 is entered. In some embodiments, the method 450 can allow a user or host of the device 431 to access the ROM block 432 of the device 431 through a verification process that includes entering or providing an access key. In these embodiments, the method 450 can be executed to receive a test mode key to authorize a user or host device that is attempting to enter the test mode and/or access the ROM block 432.

At 458 a status of the test mode key is determined. In some embodiments, determining the status of the test mode can refer to determining whether the test mode key provided at 445 was verified or denied. When the test mode key is verified, the method 450 can have a status at 446 to allow access to the ROM block 432. In contrast, the status of the test mode can prevent access to the ROM block 432 when the test mode key is not authorized.

At 459 a special block access command is received. In some embodiments, the special block access command can be a command to access the ROM block 432 in response to the test mode key being verified. That is, when the test mode key is verified and/or a user is determined to be authorized to access the ROM block 432. In previous systems and methods, a user or host device would be allowed to access the ROM block 432 in response to receiving the special block access command. However, the present disclosure provides additional security trims (e.g., ROM lock bit enable) to access the ROM block 432.

The method 450 can include determining whether the ROM lock bit enable is set. In some embodiments, the ROM lock bit enable (e.g., ROM lock bit, ROM lock enable, lock bit, etc.) can be a register bit that can indicate whether access to the ROM block 432 is allowed or not for any user or host device. In some embodiments, the ROM lock bit enable can be an OTP bit. In some embodiments, an OTP bit can be a register bit that can be programmed or written only one time.

For example, after an OTP bit is set to a particular state (usually from a default state like “0” or “1”), it cannot be reset to its original state. This irreversible nature is typically achieved through physical changes in the memory cell, such as blowing a fuse or breaking a link.

At 461 the ROM block read function is disabled in response to the ROM lock bit enable being set. In some embodiments, the ROM lock bit enable is set when the ROM lock bit enable is a first value (e.g., value of 1, etc.). In these embodiments, the first value can be programmed to the ROM lock bit enable to indicate that the ROM block 432 should not be allowed to be accessed through a test mode even when the test mode key is verified at 457 and/or 458. In this way, even users with credentials that allow access to a test mode of the device 431 will not have access to a read function or write function of the ROM block 432. This can provide additional security for the configuration settings stored on the ROM block 432.

At 462 a ROM read function is enabled in response to the ROM lock bit enable not being set. In these embodiments, the ROM lock bit enable is not set when the ROM lock bit enable is programmed with a second value (e.g., value of 0, etc.). In these embodiments, the second value can be programmed to the ROM lock bit enable to indicate that the ROM block 432 is allowed to be accessed through a test mode when the test mode key is verified at 457 and/or 458.

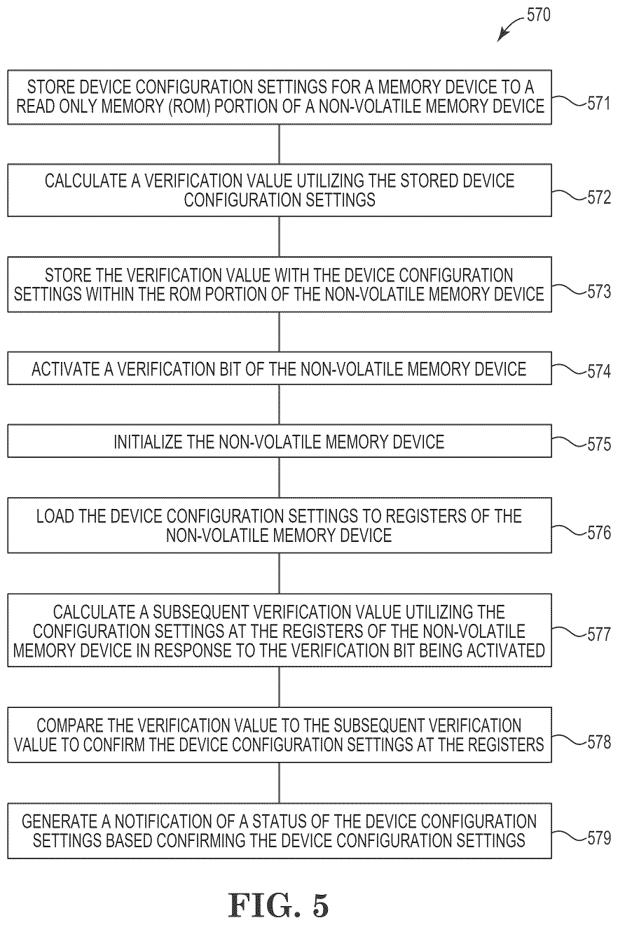

FIG. 5 is a flow diagram of another example method 570 for verifying configuration settings in accordance with some embodiments of the present disclosure. The method 570 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 570 is performed by the controller 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 571, the method 570 can include storing device configuration settings for a memory device to a read only memory (ROM) portion of a non-volatile memory device. As described herein, the ROM portion can be a protected portion of the non-volatile memory device. The ROM portion can be a designated portion of a memory device that is intended to store configuration settings that are intended to be utilized for a lifetime of the memory device. In some embodiments, the ROM portion of the non-volatile memory device can be programmed with configuration settings that include additional security trims to protect the configuration settings within the ROM from unauthorized users.

In some embodiments, the configuration settings can include, but are not limited to: configuration registers, command registers, error registers, interrupt registers, and/or other designated memory registers that can be programmed with data from the ROM portion. In some embodiments, the configuration settings can be read during an initialization or power cycle of the memory device and the configuration settings can be programmed to registers of a volatile memory portion of the memory device. The configuration settings can be utilized to monitor and/or manage the functions during operations of the memory device.

The method 570 at 572 can include calculating a verification value utilizing the stored device configuration settings. As described herein, a verification value can be a value calculated utilizing the configuration settings as input values for a selected algorithm. In some embodiments, the method 570 can be executed to calculate the verification value utilizing a portion of data stored at the ROM portion of the non-volatile memory device and appending the verification data to the portion of data utilized to calculate the verification value. That is, the calculated verification value can be calculated utilizing configuration settings while not utilizing other data stored by the ROM portion of the non-volatile memory device. In this way, the verification value can be specific to verifying the configuration settings.

The method 570 at 573 can include storing the verification value with the device configuration settings within the ROM portion of the non-volatile memory device. In some specific embodiments, the verification value is one of a: cyclic redundancy check (CRC) value, a checksum value, and a multiple input signature register (MISR) value. In some embodiments, the verification value can be appended to the device configuration settings stored within the ROM portion. As used herein, appending the verification value to the device configuration settings can include adding the verification value as a sequential addition to the configuration settings. That is, the verification value can be added to the ROM portion at the end of the configuration settings.

The method 570 at 574 can include activating a verification bit of the non-volatile memory device. As used herein, the verification bit of the non-volatile memory device can be a designated bit where the value of the designated bit can be utilized to determine whether a verification value exists with the configuration settings stored by the ROM portion. For example, a verification value can be stored with the configuration settings when the verification bit is a first value and a verification is not stored with the configuration settings when the verification bit is a second value. In this way, a device utilizing the ROM portion can determine whether to check a verification value or whether to proceed without checking a verification value.

The method 570 at 575 can include initializing the non-volatile memory device. In some embodiments, initializing the non-volatile memory device can include performing a plurality of operations to prepare the memory device for operation. For example, the non-volatile memory device can be activated or perform a power on cycle that can initiate the initialization of the non-volatile memory device to configure the memory device to be utilized. In some embodiments, the initialization of the memory device can include resetting to default states. In these embodiments, resetting to default states can include programming the configuration settings from the ROM portion to registers of the memory device.

The method 570 at 576 can include loading the device configuration settings to registers of the non-volatile memory device. As described herein, loading the device configuration settings from the ROM portion to the registers of the non-volatile memory device can be part of an initialization process to reset the non-volatile memory device to default states. In some embodiments, the device configuration settings can be programmed to corresponding registers of the non-volatile memory device and utilized to configure the operations of the non-volatile memory device.

The method 570 at 577 can include calculating a subsequent verification value utilizing the configuration settings at the registers of the non-volatile memory device in response to the verification bit being activated. As described herein, calculating the subsequent verification value includes utilizing the configuration settings at the registers as input values for the same algorithm utilized to generate the verification value stored at the ROM portion. In this way, the configuration settings that are programmed to the registers can be compared to the configuration settings that were programmed to the ROM when the verification value was generated.

The method 570 at 578 can include comparing the verification value to the subsequent verification value to confirm the device configuration settings at the registers. As described herein, the subsequent verification value is calculated utilizing the same algorithm that is utilized to generate the verification value programmed to the ROM. In this way, the verification value can be compared to the subsequent verification value to determine if the values match or if the values are different. A match between the verification value and the subsequent verification value can indicate that the configuration settings programmed to the ROM have not been changed since a time when the verification value stored to the ROM was generated. A mismatch or difference between the verification value and the subsequent verification value can indicate that the configuration settings programmed to the ROM have been changed since a time when the verification value stored to the ROM was generated.

The method 570 at 579 can include generating a notification of a status of the device configuration settings based confirming the device configuration settings. In some embodiments, the status of the device configuration can be a security risk flag when the device configuration settings are determined to be altered from a time when the verification value stored to the ROM was generated. In this example, the security risk flag can indicate that the device configuration settings being utilized at the device registers may have been altered from the original device configuration settings, which can lead to unexpected operation of the memory device.

In some embodiments, the method 570 can include activating a test mode for the non-volatile memory device in response to confirming that the device configuration settings have not been altered from a factory setting. In some embodiments, a test mode can be activated in response to confirming that the device configuration settings have not been altered and in response to a verification process (e.g., providing a correct test mode key, etc.). In this way, the verification value can be utilized in addition to the verification process to ensure that the configuration data has been unaltered from a factory setting prior to proceeding with a verification process to allow access to a test mode. As described herein, the test mode can provide access to the ROM portion of the memory and may allow the configuration settings or other data stored by the ROM portion to be altered.

In some embodiments, the method 570 can include deactivating the non-volatile memory device in response to confirming that the device configuration settings have been altered. In some embodiments, the subsequent verification value may not match the verification value stored by the ROM portion. In these embodiments, it can be determined that the configuration settings have been altered from factory configuration settings. In some of these embodiments, the non-volatile memory device can be deactivated to prevent the non-volatile memory device from entering an operating mode and/or prevent the non-volatile memory device from entering a test mode. In some embodiments, the non-volatile memory device can be prevented from entering a verification process to enter the test mode when it is determined that the configuration settings have been altered.

In some embodiments, the method 570 can include enabling a lock bit of the ROM portion of the non-volatile memory device to be activated in response to the device configuration settings being within a threshold accuracy. In these embodiments, the lock bit of the ROM portion of the non-volatile memory device is an OTP bit associated with allowing or denying alterations to data stored at the ROM portion of the non-volatile memory device. As described herein, a lock bit can be utilized to prevent access to the ROM portion of the non-volatile memory device even when the configuration settings are determined to be valued by comparing the verification value of the ROM portion to a subsequent verification value.

In this way, the lock bit of the ROM portion can be utilized in combination with the verification bit value and/or verification value. This can allow the configuration settings of the ROM portion to be validated even when the lock bit of the ROM portion has been enabled to prevent access to the ROM portion.

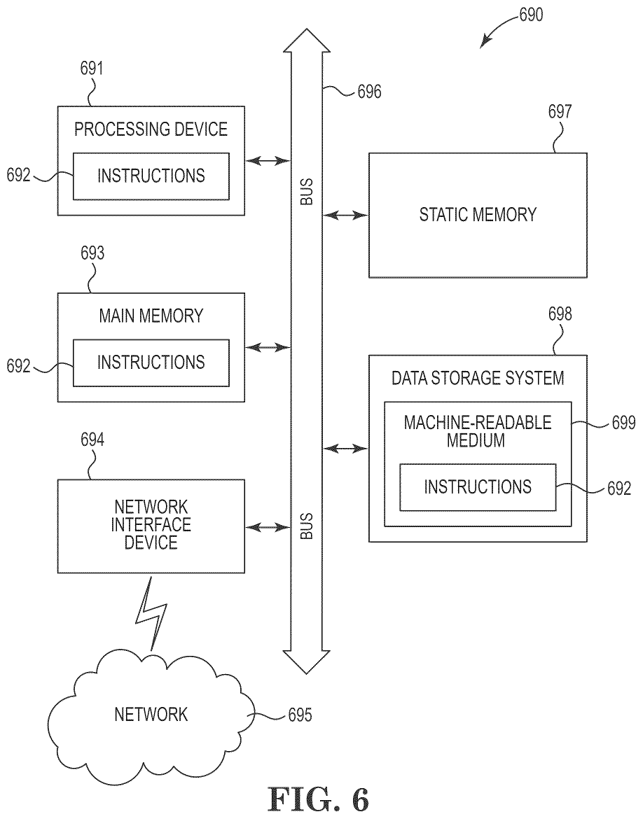

FIG. 6 is a block diagram of an example computer system 690 in which embodiments of the present disclosure may operate. For example, FIG. 6 illustrates an example machine of a computer system 690 within which a set of instructions, for causing the machine to perform any one or more of the methodologies discussed herein, can be executed. In some embodiments, the computer system 690 can correspond to a host system (e.g., the host 102 of FIG. 1) that includes, is coupled to, or utilizes a memory system or can be used to perform the operations of a controller (e.g., to execute an operating system to perform operations corresponding to the controller 108 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

The processing device 691 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media. The machine-readable storage medium 699, data storage system 698, and/or main memory 693 can correspond to the device 331 of FIG. 3 and/or FIG. 4.

In one embodiment, the instructions 692 include instructions to implement functionality corresponding to the syndrome calculation circuitry (e.g., the controller 108 of FIG. 1). While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
an array of non-volatile memory cells;
a protected memory configured to store:
configuration settings for the apparatus; and
a lock bit;
a controller coupled to the array and to the protected memory and configured to:
read the protected memory in response to an initialization of the apparatus;
prevent alteration of data stored in the protected memory in response to the lock bit having a first value; and
allow alteration of the data stored in the protected memory in response to the lock bit having a second value.

2. The apparatus of claim 1, wherein the lock bit is a one-time programmable (OTP) bit.

3. The apparatus of claim 1, wherein the controller is further configured to allow an erase operation to be performed on the protected memory regardless of the value of the lock bit.

4. The apparatus of claim 3, wherein the erase operation erases all of the configuration settings.

5. The apparatus of claim 1, wherein the lock bit is programmed in response to the configuration settings being programmed.

6. The apparatus of claim 1, wherein the controller is further configured to:
load the configuration settings from a ROM portion to status registers of a NAND memory device;
receive a command to access the ROM portion of the NAND memory device;
read the lock bit in response to the command;
prevent a write operation of data to the ROM portion when the read lock bit is activated; and
allow a write operation of data to the ROM portion when the read lock bit is deactivated.

7. An apparatus, comprising:
an array of non-volatile memory cells;
a protected memory configured to be programmed during manufacturing of the apparatus to store:
configuration settings for the apparatus;
an initial verification value calculated based on the configuration settings; and
a verification value enabled indicator;
a controller coupled to the array and to the protected memory and configured to:
read the protected memory in response to an initialization of the apparatus;
calculate a subsequent verification value based on the configuration settings stored to the protected memory in response to reading the verification value enabled indicator;
compare the subsequent verification value to the initial verification value stored in the protected memory;
verify the device configuration settings in response to the subsequent verification value matching the initial verification value; and
take a security action in response to the subsequent verification value being different from the initial verification value.

8. The apparatus of claim 7, wherein the controller is configured to set a flag or update a value in a status register as the security action.

9. The apparatus of claim 7, wherein the controller is configured to disable commands for the apparatus as the security action.

10. The apparatus of claim 7, wherein the controller is further configured to activate a test mode for the memory device in response to:
receipt of a correct key to unlock the test mode; and
the subsequent verification value matching the initial verification value.

11. The apparatus of claim 10, wherein the test mode enables editing of data stored by the protected memory; and
wherein the protected memory is a read only memory (ROM) block or a one-time programmable (OTP) bit.

12. The apparatus of claim 7, wherein the controller is further configured to load the device configuration settings to status registers of the apparatus and calculate the subsequent verification value utilizing the device configuration settings stored at the status registers; and
wherein the device configuration settings include trims data, read error management data, and a fuse identification of the memory device.

13. The apparatus of claim 7, wherein the controller is further configured to:
read the protected memory intermittently;
calculate an additional subsequent verification value based on the device configuration settings stored to the protected memory in response to reading the verification value enabled indicator;
compare the additional subsequent verification value to the initial verification value stored in the protected memory;
verify the device configuration settings in response to the additional subsequent verification value matching the initial verification value; and
take the security action in response to the additional subsequent verification value being different than the initial verification value.

14. A method, comprising:
storing device configuration settings to a read only memory (ROM) portion of a non-volatile memory device;
calculating a verification value utilizing the stored device configuration settings;
storing the verification value with the device configuration settings within the ROM portion of the non-volatile memory device;
activating a verification bit of the non-volatile memory device;
initializing the non-volatile memory device;
loading the device configuration settings to registers of the non-volatile memory device;
calculating a subsequent verification value utilizing the configuration settings at the registers of the non-volatile memory device in response to the verification bit being activated;
comparing the verification value to the subsequent verification value to confirm the device configuration settings at the registers; and
generating a notification of a status of the device configuration settings based confirming the device configuration settings.

15. The method of claim 14, further comprising activating a test mode for the non-volatile memory device in response to confirming that the device configuration settings have not been altered from a factory setting.

16. The method of claim 14, further comprising deactivating the non-volatile memory device in response to confirming that the device configuration settings have been altered.

17. The method of claim 14, further comprising enabling a lock bit of the ROM portion of the non-volatile memory device to be activated in response to the device configuration settings being within a threshold accuracy.

18. The method of claim 17, wherein the lock bit of the ROM portion of the non-volatile memory device is a one-time programmable (OTP) bit associated with allowing or denying alterations to data stored at the ROM portion of the non-volatile memory device.

19. The method of claim 14, wherein the verification value is one of a: cyclic redundancy check (CRC) value, a checksum value, and a multiple input signature register (MISR) value.

20. The method of claim 14, further comprising calculating the verification value utilizing a portion of data stored at the ROM portion of the non-volatile memory device and appending the verification data to the portion of data utilized to calculate the verification value.
